(19) United States
(12) Patent Application Publication
(10) Pub. No.: US 2005/0117663 A1
(43) Pub. Date: Jun. 2, 2005

(54) Chip set for digital audio satellite radio receivers

(76) Inventors: Serge Drogi, Phoenix, AZ (US); Mihai Murgulescu, San Jose, CA (US); Hans Dropmann, Emerald Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/933,647

(22) Filed: Sep. 3, 2004

Related U.S. Application Data
(63) Continuation-in-part of application No. 10/727,230, filed on Dec. 2, 2003.
(60) Provisional application No. 60/556,413, filed on Mar. 24, 2004.

(51) Int. Cl. H04B 15/00

(52) U.S. Cl. 375/316

(57) ABSTRACT

A digital audio radio system includes a radio frequency (RF) integrated circuit (IC) and a baseband digital signal processing (DSP) IC to receive digital audio radio signals from satellites and terrestrial antennae. A serial digital interface couples data between the RF IC and the baseband DSP IC to provide a high data rate and low noise. In one embodiment, the RF IC has a single bit sigma delta modulator to convert an analog signal into a serial digital bit stream, and a low voltage differential output driver to reduce the output voltage swing of the serial digital bit stream. The DSP IC has a low voltage differential input receiver to increase the output voltage swing of the serial digital bit stream in the DSP IC, a decimator to lower the data rate of the serial digital bit stream, and a demodulator to convert the serial digital bit stream into parallel digital data samples for digital signal processing by the DSP IC.

### CROSS REFERENCE TO RELATED APPLICATIONS

This non-provisional United States (U.S.) patent application claims the benefit of U.S. Provisional Application No. 60/556,413 filed on Mar. 24, 2004 by inventors Serge Drogi et al., entitled “CHIP SET FOR DIGITAL AUDIO SATELLITE RADIO RECEIVERS” and further claims the benefit of and is a continuation in part (CIP) of U.S. patent application Ser. No. 10/727,230, filed on Dec. 2, 2003 by inventors Serge Drogi et al., entitled “METHOD, APPARATUS, AND SYSTEMS FOR DIGITAL RADIO COMMUNICATION SYSTEMS” which is incorporated herein in its entirety by reference, all of which are to be assigned to Maxim Integrated Products, Inc.

### FIELD OF THE INVENTION

The invention generally relates to satellite radio receivers. The invention more particularly relates to digital audio satellite radio receivers.

### BACKGROUND OF THE INVENTION

The typical FM radio is well known and usually consists of a plurality of analog circuits. The typical FM radio signal uses an analog signal that is modulated by an analog source signal. The introduction of digital tuning allows the carrier frequency to be digitally selected using a minimal amount of digital circuitry.

More recently, digital audio radio has been introduced. The audio source signals are digital data that are broadcast and received by a digital audio radio receiver. The digital audio radio receiver continues to require an analog front end in order to receive and/or transmit a signal through space. However, the back end processing is performed by digital circuitry.

In the digital audio radio receiver, multi-bit parallel analog to digital converters are often used to convert a baseband analog signal into a multi-bit parallel binary value representing a digital number. The digital number may then be processed by a digital signal processor. The multi-bit parallel analog to digital converters require significant area over an integrated circuit. Additionally, multi-bit parallel analog to digital converters are usually manufactured using special silicon manufacturing processes as they are mixed signal devices. The silicon manufacturing processes employed effects the cost of a radio. By eliminating the multi-bit parallel analog to digital converter, the cost of the radio may be further reduced.

In the typical analog front end, active analog filters are used. If most, if not all, active analog filters can be eliminated from the analog integrated circuits of the radio, power can be conserved and die size reduced, leading to lower costs and increased battery usage time in battery operated devices.

In order to promote digital satellite radio services, it is desirable to lower the hardware costs of the radio receiver so that the services are more widely accepted by end users.

### BRIEF SUMMARY OF THE INVENTION

The invention is briefly summarized by the claims.

The invention is briefly summarized by the claims.

In one embodiment, a digital audio satellite radio receiver is provided including a radio frequency receiver integrated circuit and a processor coupled to the radio frequency receiver integrated circuit. The radio frequency receiver integrated circuit includes a modulating analog to digital converter with an analog input and a serial digital output. The analog input of the modulating analog to digital converter receives a digital audio satellite radio signal. The output driver has an input that is coupled to the serial digital output of the modulating analog to digital converter, and a digital output.

In another embodiment, a digital audio radio is provided with an antenna, a radio frequency receiver integrated circuit coupled to the antenna, and a digital signal processing integrated circuit coupled to the radio frequency receiver integrated circuit. The antenna extracts a digital audio radio signal broadcast from at least one satellite in geosynchronous orbit with the earth as an analog signal. The radio frequency receiver integrated circuit includes a single bit modulator to convert the analog signal into a serial digital bit stream. The digital signal processing integrated circuit receives the serial digital bit stream and extracts a digital audio signal from the serial digital bit stream.

In another embodiment, a digital audio radio frequency integrated circuit is disclosed. The digital audio radio frequency integrated circuit is to couple to an antenna to receive a wireless digital audio signal. The digital audio radio frequency integrated circuit includes an amplifier to couple to the antenna; a single bit modulator coupled to the amplifier; and an output driver coupled to the single bit modulator. The amplifier receives a wireless digital audio signal as an analog signal. The single bit modulator converts the analog signal into a serial digital bit stream. The output driver drives the serial digital bit stream out from the radio frequency integrated circuit to a digital signal processing integrated circuit.

In yet another embodiment of the invention, a digital audio radio frequency integrated circuit is disclosed including at least one gain amplifier to couple to an antenna, at least one down converter coupled to the at least one gain amplifier, at least one single bit sigma delta modulator coupled to the at least one down converter, and at least one output driver coupled to the at least one single bit sigma delta modulator. The at least one gain amplifier couples to the antenna to receive a first digital audio radio frequency signal of a first selectable carrier frequency. The at least one down converter extracts a first analog signal from the first wireless radio frequency signal. The at least one single bit sigma delta modulator converts the first analog signal into a first serial digital bit stream. The at least one output driver provides a low voltage output swing of the first serial digital bit stream to reduce noise generation as the first serial digital bit stream is coupled to another integrated circuit.

In still another embodiment, a system includes a radio frequency integrated circuit and a processor coupled to the radio frequency integrated circuit. The radio frequency integrated circuit includes a modulating analog to digital converter with a single bit output and an output driver coupled to the single bit analog to digital converter. The modulating analog to digital converter converts an analog input signal of a digital audio signal into a serial digital bit output stream. The output driver drives the serial digital bit stream out from the radio frequency integrated circuit. The processor is coupled to the radio frequency integrated circuit to receive the serial digital bit stream and recover the digital audio signal.

In another embodiment of the invention, a digital audio satellite system is provided including at least one satellite in geosynchronous orbit with the earth, and a digital radio with an antenna to receive wireless digital audio signals. The at least one satellite broadcasts the wireless digital audio signals to a portion of the earth over a carrier frequency. To receive the wireless digital audio signals, the digital radio includes a radio frequency integrated circuit and a digital signal processing integrated circuit. The radio frequency integrated circuit has a single bit sigma delta modulator with an analog input and a serial digital output, and an output driver having an input coupled to the serial digital output of the single bit sigma delta modulator. The output driver of the radio frequency integrated circuit has a differential output. The digital signal processing integrated circuit has an input receiver coupled to the output driver of the radio frequency integrated circuit. The input receiver has a differential input to couple to the differential output of the output driver. The input receiver of the digital signal processing integrated circuit has a serial digital output.

### BRIEF DESCRIPTION OF THE DRAWINGS

FIG. 1 is a block diagram of an exemplary digital audio radio system employing the invention.

FIG. 2 is a block diagram of a chip set for a digital audio radio receiver including a radio receiver integrated circuit (IC) and a baseband digital signal processing (DSP) IC of one embodiment of the invention.

FIG. 3 is a magnified view of the block diagram of the radio receiver integrated circuit (IC) of FIG. 2.

FIG. 4 is a magnified view of the block diagram of the baseband digital signal processing (DSP) integrated circuit (IC) of FIG. 2.

FIG. 5 is a block diagram to illustrate details of a receive channel of a digital interface between a radio integrated circuit (IC) and a baseband digital signal processing (DSP) IC.

### DETAILED DESCRIPTION OF THE PREFERRED EMBODIMENTS

In the following detailed description of the invention, numerous specific details are set forth in order to provide a thorough understanding of the invention. However, one skilled in the art would recognize that the invention may be practiced without these specific details. In other instances well known methods, procedures, components, and circuits have not been described in detail so as not to unnecessarily obscure aspects of the invention.

The invention includes methods, apparatuses and systems for radio frequency integrated circuits and digital signal processing integrated circuits. The invention provides a new and optimized way to exchange radio received signals between a radio receiver integrated circuit and a digital processing circuit.

The invention is particularly applicable to digital satellite radio systems but may be also used in other types of radios. The invention simplifies the physical interface (e.g., reduces the number of pins and thereby eases printed circuit board design), simplifies the control layers (by providing a high dynamic range), enables software control (flexible in that band changes, code changes, filter changes, mode changes, etc. can be made by software control), lowers costs, and conserves power.

The invention uses a combination of analog to digital conversion, digital coding, high-speed digital interface and digital filtering to achieve transfer of information between two integrated circuits (ICs) over a serial digital bit stream. Received radio signals are converted to a digital format within the radio frequency IC. The digital format of the received radio signals are communicated to a digital processing IC over the high speed digital interface by means of the serial digital bit stream. The digital processing IC performs digital filtering and does no analog processing of the radio signal. The digital processing IC avoids costly analog processing blocks and therefore can be manufactured in lower cost digital manufacturing processes.

In one embodiment, the digital interface includes an analog to digital converter built as a sigma delta modulator with a single bit digital stream output, a low voltage differential signal transmitter, a matched differential line to provide a physical connection, and a low voltage differential signal receiver with subsequent digital data recovery and signal processing. The configuration of elements with the high speed digital interface between the radio IC and the digital processing IC enables high dynamic range signals to be transferred to the digital IC where they can be digitally filtered.

That is, the digital format chosen supports multiple data transfer rates, and thus applies to many different radio protocols, in particular it spans from narrow to wide band radio systems. It also supports very high data rates, up to hundreds of mega-bits per second, and thus is suitable for transfer of simultaneous satellite and ground multicast radio signals, which have a high dynamic range, requiring higher over-sampled data rates.

To support the digital interface, modulators/decimators are utilized. Multiple modulation/demodulation standards may be used including sigma-delta modulation/demodulation, also referred to as delta-sigma modulation/demodulation. In a preferred embodiment, the encoding of the signal is realized using a multi rate sigma-delta modulator with two levels of quantization, a single bit modulator, to generate a digital bit serial data stream.

The digital format being a low voltage differential signal and the coding generating a single digital bit serial data stream inherently provides low spurious radio emissions, which is important in any radio receiver. Moreover, a data rate clock does not need to be explicitly transmitted with the signal of the single digital bit serial data stream, thereby eliminating another source of spurious emission.

The digital format and coding chosen does not require the formatting of the information into parallel words and therefore there is no need for handshake synchronization to realize data transfer. Transferring data in parallel consumes power due to the output drivers having to drive high capacitive loads. Transferring data serially lowers current/power consumption. Moreover, fewer lines change state between integrated circuits, reducing another source of radio spurious emissions. Eliminating handshake synchronization signals also eliminates another source of radio spurious emissions and current/power consumption. Moreover, the number of pins used for the integrated circuit is reduced when serially transmitting data and avoiding the use of hand shake synchronization signals.

At a physical level, the digital interface uses low voltage differential signaling to provide low current/power consumption, high-speed data transfer, and low spurious emissions.

The digital interface optimizes power consumption within the digital satellite radio receiver as it minimizes digital signal processing performed by the radio frequency analog integrated circuit and minimizes analog signal processing performed by the digital signal processing integrated circuit. The radio frequency analog integrated circuit, which receive the analog signals with an antenna, use Silicon manufacturing techniques optimized for analog processing. Silicon manufacturing techniques optimized for analog signal processing often have lower performance when used for digital signal processing, in comparison with Silicon manufacturing processes optimized for digital signal processing. Similarly, Silicon manufacturing techniques optimized for digital signal processing often have lower performance when used for analog signal processing, in comparison with Silicon manufacturing processes optimized for analog signal processing. The use of the disclosed digital interface between the RF analog integrated circuit and the baseband DSP integrated circuit, suppresses a need to perform analog signal processing in the baseband DSP integrated circuit and digital signal processing in the RF analog integrated circuit, easing their design and manufacture. Complex mixed signal circuits are avoided by employing the disclosed digital interface between the RF analog integrated circuit and the baseband DSP integrated circuit. The digital interface is provided to optimize the overall design and manufacture of the radio transceiver.

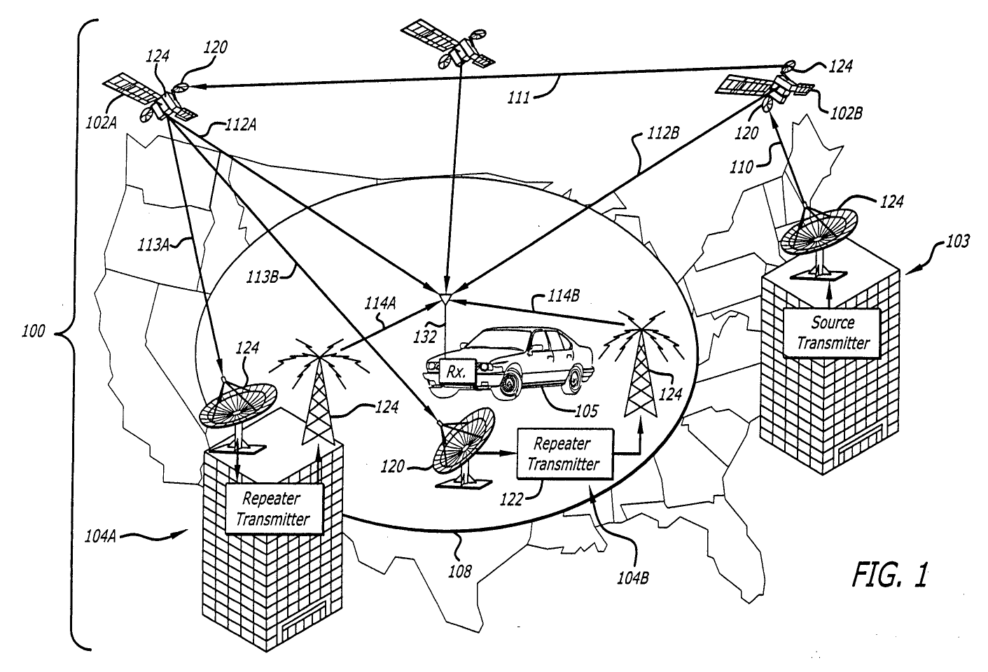

Referring now to FIG. 1, a block diagram of an exemplary digital audio radio system 100 including the invention is illustrated. In one embodiment, the digital audio radio system 100 is a satellite digital audio radio service (SDARS) system incorporating the invention. In the United States, the digital audio radio system 100 may be an XM satellite radio system or a Sirius satellite radio system using different center carrier frequencies over a frequency band. Other countries may use different carrier frequencies for their satellite digital audio radio service (SDARS) systems in different frequency bands.

The digital audio radio system 100 includes one or more satellites 102A-102B, a source station 103, one or more ground stations 104A-104B, and one or more subscriber units 105. The subscriber units 105 may be mobile or stationary. If mobile, the subscriber units may be part of a moving vehicle such as a boat plane, car, train, helicopter, etc. The subscriber units 105 may also be referred to as a satellite radio tuner or receiver, and a digital audio receiver or radio receiver.

The one or more satellites 102A-102B, the one or more ground stations 102A-102F, and their respective one or more antennas, form a service area 108. The service area 108 may be for a single analog carrier frequency. One or more service areas 108 may coexist over the same country using different analog carrier frequencies or the same analog carrier frequency but with different digital encoding. Alternatively, with additional satellites and ground stations, a worldwide service area may be formed using a single analog carrier frequency. One or more service areas 108 in one or more countries may use other analog carrier frequencies or multiple analog carrier frequencies in service areas.

The same radio sources from the lone source station 103 may be broadcast over the one or more service areas 108. Alternatively, other source stations (not shown in FIG. 1) may contribute to the source programs that are broadcast into the one or more service areas 108.

The one or more satellites 102A-102B, the source station 103, the one or more ground stations 104A-104B, and the one or more subscriber units 105 of the digital satellite radio system communicate between each other using wireless communication signals. The source material is digitally encoded for communication over the wireless communication signals between the elements of the digital satellite radio system. Source material is uplinked from the source station 103 to the satellite 102B over the wireless communication signals 110. Satellite 102B may communicate the same source material to another satellite 102A by means of the wireless communication signals 111. The satellites 102A and 102B may directly broadcast the source material to the one or more subscriber units 105 by means of wireless communication signals 112A and 112B, respectively. Alternatively, satellites 102A and 102B may transmit the source material to the ground stations 104A and 104B by means of wireless communication signals 113A and 113B, respectively, and the ground stations 104A and 104B may directly broadcast the source material to the one or more subscriber units 105 by means of wireless communication signals 114A and 114B, respectively.

In order to broadcast the digital satellite radio signals (i.e., the wireless communication signals 112A, 112B, 114A, and 114B), each of the satellites 102A and 102B and ground stations 104A and 104B includes a receiving antenna 120, a radio receiver/transmitter (i.e., transceiver) 104, and a transmitting antenna 124. The radio receiver/transmitter 104 acts like a repeater but may also convert one wireless communication signal into another.

In order to receive the digital satellite radio signals (i.e., the wireless communication signals 112A, 112B, 114A, and 114B), each of the one or more subscriber units 105 includes a receiving antenna 132 and a receiver (RX) 134 coupled together. As discussed previously, the one or more subscriber units 105 may be mobile or stationary. If mobile, the subscriber unit 105 may be a part of a vehicle or a portable electronic system. If stationary, the subscriber unit 105 may be part of a home electronic or home theatre system, for example.

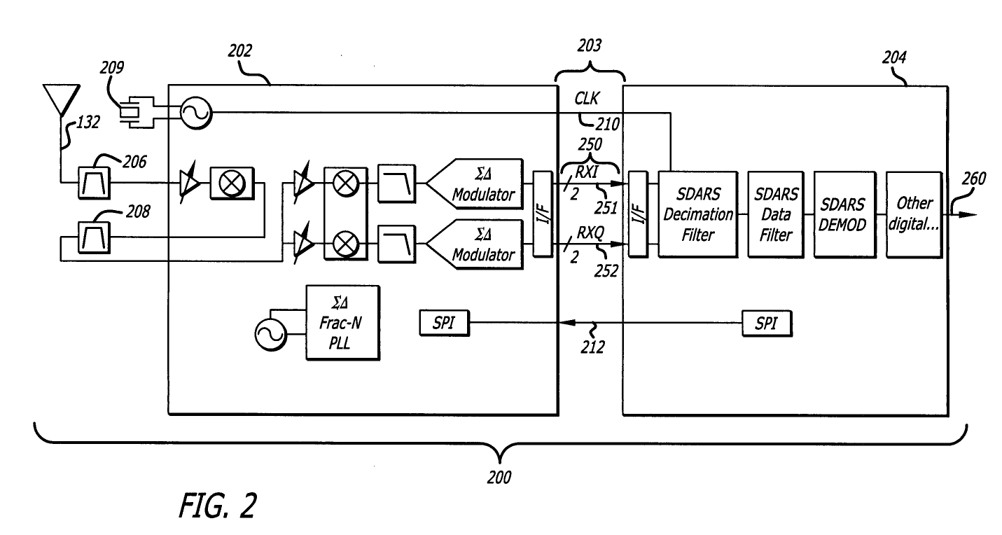

Referring now to FIG. 2, a block diagram of a digital audio radio receiver 200 for the one or more subscriber units 105 of the digital audio radio system 100 is illustrated. The digital audio radio receiver 200 includes a radio receiver integrated circuit (IC) 202 and a baseband digital signal processing (DSP) IC 204 coupled together as shown. The baseband digital signal processing IC or chip 204 may be one or more digital signal processor integrated circuits or a programmable general purpose processor, such as a microprocessor, with program instructions to provide digital signal processing.

The antenna 132 of the subscriber unit 105 couples to the radio receiver integrated circuit (IC) 202 through a first passive external filter 206 to receive radio waves. The first passive external filter 206 is a low pass filter. A second passive external filter 208 couples to the radio receiver integrated circuit to filter out noise generated in the down conversion process.

An external quartz crystal 209 is coupled to an internal clock generator in one embodiment in order to generate a clock 210 for the radio receiver integrated circuit (IC) 202 and the baseband digital signal processing (DSP) IC 204. The clock 210 generated by the clock generator is coupled from the radio receiver IC 202 into the baseband DSP IC 204. In one embodiment, the clock signal 210 is a 24 MHz clock. A serial control bus 212 may couple from the baseband DSP IC 204 into the radio receiver IC 202 to control the selection of carrier frequencies/channels and tailor the RF integrated circuits for the wireless communication channels with a selected digital audio radio system.

The radio receiver integrated circuit (IC) 202 receives analog radio frequency signals, performs analog signal processing, and converts them into one or more serial digital bit streams to be coupled into the baseband DSP IC 204. The baseband digital signal processing (DSP) IC 204 digitally processes the one or more serial digital bit streams and performs digital filtering to extract the received digital data from the wireless communication link. The one or more serial digital bit streams may be in a low voltage differential signal format.

A digital interface 250 is provided between the radio receiver IC 202 and the baseband DSP IC 204 to couple digital data between them. The interface 250 between radio integrated circuits (e.g., the radio frequency receiver IC and the baseband digital signal processing (DSP) IC in the invention is a digital serial interface. Typical mixed signal circuitry employed between radio ICs and the baseband DSP IC has been eliminated by the invention. Typically a mixed signal coder/decoder (codec) IC was employed as the mixed signal interface or mixed signal codec circuitry was placed on the DSP IC. The new digital interface, one aspect of the invention, is employed between the radio receiver IC and the baseband DSP IC to eliminate a mixed signal interface. The invention reduces system cost by eliminating the mixed signal interface. Analog circuitry is not needed between or on the baseband DSP IC. Without analog circuitry on the baseband DSP IC, faster migration of the baseband DSP IC to circuits with smaller process manufacturing technologies can be had further reducing costs of the baseband DSP IC. Moreover, the digital interface may use a low voltage differential swing to support high-speed data transfer between the radio frequency receiver IC and the baseband DSP IC.

As one aspect of the invention, the system 200 includes the digital interface 250 between the radio receiver IC 202 and the baseband digital signal processing (DSP) IC 204. The digital interface 250 in the system 200 of FIG. 2 is one or more receive channels 251-252. Each channel is a digital serial bit stream. A parallel digital word is not employed in order to reduce a large number of I/O traces that otherwise would be needed. The digital serial bit interface reduces the noise that would otherwise be generated by parallel data bus traces that may otherwise interfere with radio frequency signals. A digital serial bit interface further eliminates any noise sensitive analog traces that otherwise might have been used between the radio receiver IC and the baseband DSP IC.

Each channel may communicate using a low voltage swing differential signal, in which case two wire traces are used for each. That is for each channel, a pair of wire traces between the radio frequency integrated circuit 202 and the baseband digital signal processing IC 204 carry a differential signal there-between. The one or more receive channels 251-252 include an in-phase or real component receive channel (RX I) and the quadrature or imaginary component receive channel (RX Q) which are mirror images of one another but carry different data. RX I channel 251 and a RX Q channel 252 for complex data including imaginary and real terms (e.g., S=Q+Ij). In an alternate embodiment, the RX I channel and a RX Q channel may be interleaved into one RX channel. In yet another embodiment, the RX Q channel and RX I channel are magnitude data and phase data of a multiphase signal S, where S=Qe^{jI}. These are also sometimes referred to as polar coordinates.

The I and Q bit streams are transported separately in the typical implementation over the interface between the radio frequency integrated circuits and the baseband DSP integrated circuit. However, I and Q may also be interleaved onto the same pair of differential serial signal lines. With respect to polarity, the I component leads the Q component for negative frequency deviations.

In a preferred embodiment of the invention, a sigma delta clock SDCK, used to oversample the input signal to the sigma-delta modulators, is transmitted to the baseband DSP integrated circuit in a form of a low voltage swing differential signal. In an alternate embodiment of the invention, the sigma delta clock SDCK is not actually transmitted from the RF integrated circuit to the baseband DSP integrated circuit. Instead, the baseband DSP integrated circuit uses special circuitry to recover it from the data stream 251-252.

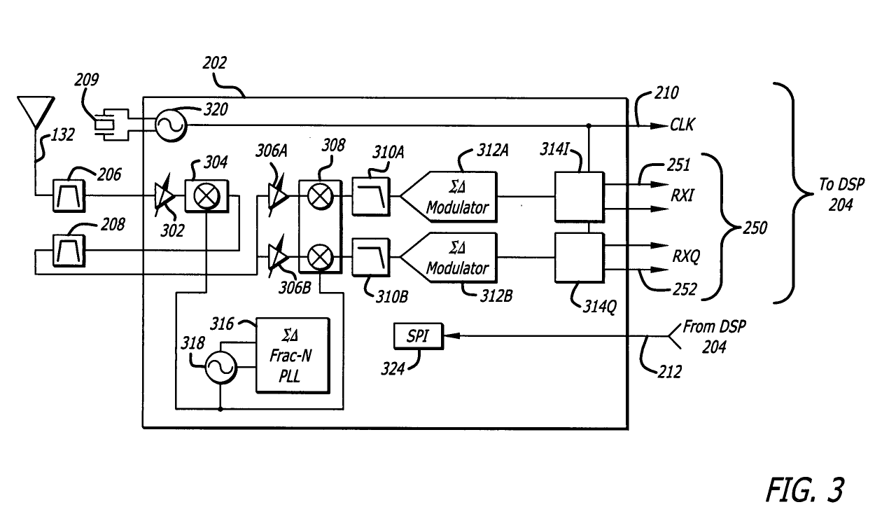

Referring now to FIG. 3, a magnified block diagram of the radio frequency receiver integrated circuit 202 is illustrated. The radio frequency receiver integrated circuit 202 includes a programmable gain low noise amplifier 302; a first mixer 304 also referred to as a down converter; a pair of programmable gain low noise amplifiers 306A, 306B; a pair of mixers 308, also referred to as down converters; a pair of passive filters 310A, 310B; a pair of sigma-delta modulators (ΣΔ Mod) 312A, 312B; a pair of low voltage differential output drivers 314I, 314Q; a low voltage differential output driver 314SDCK; programmable phase locked loops (Frac-N PLL) 316A-316B; one or more local oscillators 318A-318B; a frequency controlled clock generator 320; and a serial peripheral interface (SPI) 324 coupled together as shown and illustrated in FIG. 3.

The programmable gain amplifier (PGA) 306A, the mixer or down-converter 308, the analog prefilter 310A, the sigma-delta modulator 312A, and the low voltage differential output driver 314I coupled in series together may be referred to as the I receive channel in the radio frequency IC 202. The programmable gain amplifier (PGA) 306B, the mixer or down-converter 308, the analog prefilter 310B, the sigma-delta modulator 312B, and the low voltage differential output driver 314Q coupled in series together may be referred to as the Q receive channel in the radio frequency IC 202.

The first programmable gain low noise amplifier 302 receives the analog radio frequency signal from the digital audio radio system after being low pass filtered by the filter 206. The amplifier 302 amplifies the filtered signal for further analog signal processing. The mixer 304 is coupled to the output of the amplifiers 302 and down converts the analog radio frequency signals into an intermediate or baseband frequency analog signal. The output of the mixer 304 is coupled into the second passive filter 208. The second passive filter 208 filters out the noise generated by the mixer 304.

The inputs of the pair of amplifiers 306A, 306B are coupled together to the output of the second passive filter 208 to receive a filtered output from the mixer 304 and amplify its gain and generate duplicate signals. The pair of mixers 308 are coupled to the respective outputs of the amplifiers 306A, 306B and down converts the analog radio frequency signals into an intermediate or baseband frequency analog signal, generating an in-phase or real (I) component and a quadrature phase or imaginary (O) component of the analog signal.

The programmable phase locked loop (Frac-N PLL) 316A couples to and controls the local oscillator 318A. The local oscillator 318A selectively generates a carrier frequency signal for the carrier frequency of the digital radio system which is coupled into the first mixer 304 and the pair of mixers 308. It is this carrier frequency signal that is used to strip away the carrier frequency from the analog radio frequency signals. In other words, with the carrier frequency signal the mixers extract analog data signals at baseband frequencies from the received analog signals at the center of the carrier frequency.

The programmable phase locked loop (Frac-N PLL) 316B couples to and controls the local oscillator 318B. The local oscillator 318B selectively generates a sigma-delta clock SDCK which is coupled to the sigma-delta modulators 312A-312B and into the low voltage differential output driver 314SDCK to generate the output sigma-delta clock signal SDCK 253 which is coupled into the baseband DSP IC.

Analog filtering is employed within the RF IC 202 which may be passive or active. Channel filtering is subsequently completed in the digital domain by digital filters in the baseband DSP IC 204. The design is optimized such that the filtering performed in the digital domain by digital filters in the baseband DSP IC removes the undesired signals and with no extra effort. The digital filters in the baseband DSP IC also filter out the inherent quantization noise added to the signal by the single bit modulation performed by the sigma-delta modulators 312A, 312B.

The analog filters 310A, 310B are analog filters that protect the sigma-delta data modulators 312A, 312B from high interference signals. The analog filters 310A, 310B are low-pass filters in the baseband frequency of interest. These analog filters 310A, 310B filter out the unwanted frequency of signals generated by the down converters 308.

The pair of sigma-delta modulators (ΣΔ Mod) 312A, 312B are coupled respectively to the I and Q component outputs of the one pair of mixers 308 to receive the analog I and Q signals. The sigma-delta modulators 312A, 312B are over sampling quantizers and essentially convert an analog signal into a serial digital bit stream. That is, the pair of sigma-delta modulators (ΣΔ Mod) 312A, 312B quantize and convert the I and Q analog signals into I and Q serial digital bit signals.

In another embodiment, the sigma-delta modulators 312A, 312B may be delta modulators. In yet another embodiment, the sigma-delta modulators 312A, 312B may be modulating analog-to-digital converters with a single digital bit output to provide a serial bit stream (e.g., an analog-to-digital converter combined with a modulator having a single bit output). In any case, the modulators 312A, 312B are a type of modulator that receive an analog input signal and have a single bit output to provide a serial digital data stream. Collectively, the various types of modulators may be referred to herein as single bit modulators or modulating analog-to-digital converters with a single bit output.

In comparison with the baseband signal, the sigma-delta modulators 312A, 312B over sample the analog signal at a rate much greater than the Nyquest rate in response to the frequency of the sigma-delta clock SDCK 253. The analog signal is quantized into two levels as a digital signal with a high voltage swing between a pair of high voltage difference logic levels (e.g., ground and VCC or −VCC and +VCC). Over time as more samples of the analog signals are taken by the sigma-delta modulators 312A, 312B, a pair of single ended serial digital bit streams are formed having the high voltage difference logic levels.

The frequency of the sigma-delta clock SDCK 253 and the sampling rate of the sigma-delta modulators 312A, 312B varies depending upon the type of digital audio radio system and its frequency bands.

The I and Q serial digital bit signals and the oversampling clock are then respectively coupled into the low differential voltage output drivers 314I, 314Q, 314SDCK to generate a differential signal with a low voltage swing to speed data transfer external to the chip and lower noise generation.

The low voltage differential output drivers 314I, 314Q receive the single ended serial digital bit stream (I and Q bit streams) from the sigma-delta modulators 312I, 312Q having the high voltage swing between the pair of high voltage difference logic levels (e.g., ground and VCC). In response to the single ended digital signal with the high voltage swing between the pair of high voltage difference logic levels, the low voltage differential output drivers 314I, 314Q, 314SDCK generate a double ended low voltage swing differential signal between a pair of low voltage difference logic levels. The low voltage differential output drivers 314I, 314Q, 314SDCK each couple to a pair of wire traces between the radio frequency integrated circuit 202 and the baseband digital signal processing IC 204 to carry the differential signal there-between.

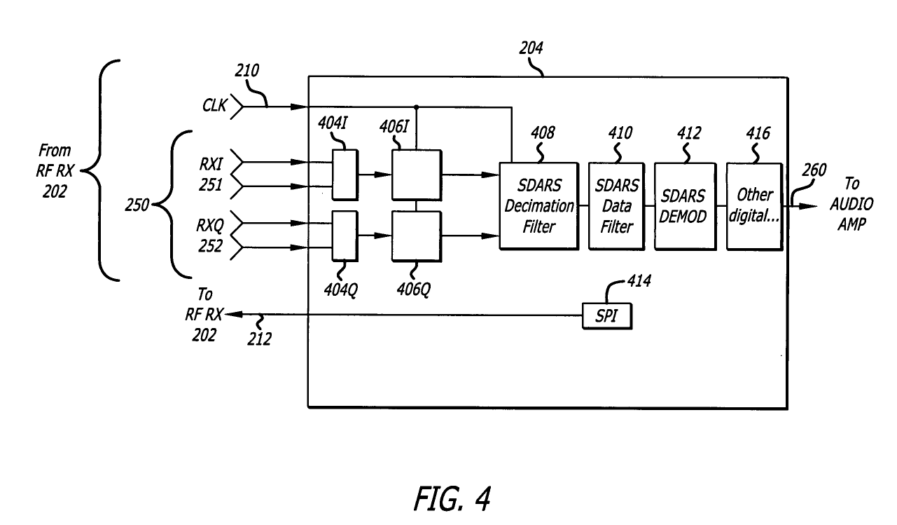

In one embodiment, the low voltage differential output drivers 314I, 314Q, 314SDCK can generate logic levels and the low voltage differential input receivers (404I, 404Q, 404SDCK illustrated in FIG. 4) can receive logic levels in accordance with a modified LVDS standard of differential signals. In which case, the electrical characteristics of these modified LVDS signals communicated over the interface 250 are:

| PARAMETER | CONDITIONS | MIN | TYP | MAX | UNIT |
|---|---|---|---|---|---|
| Output Common Mode | | 1.125 | 1.2 | 1.275 | V |
| Output Differential | | 0.112 | 0.14 | 0.168 | Vp |
| Swing | | | | | |
| Single Ended Output | High current mode: | 92 | 115 | 138 | Ω |
| Resistance | | | | | |
| Single Ended Output | Lower current mode: | | 230 | | Ω |
| Resistance | | | | | |
| Eye pattern opening | window measured at +/− | 4 | 5 | | ns |
| | 20% of max swing | | | | |
| | I Q mode | | | | |
| | window measured at +/− | 1 | 1.5 | | ns |
| | 20% of max swing | | | | |
| | interleaved mode | | | | |

The LVDS standard is described in an American National Standards Institute specification titled “Electrical Characteristics of Low Voltage Differential Signaling (LVDS) Interface Circuits” published on Jan. 1, 2001 as ANSI TIA/EIA-644-A.

In comparison with the standard LVDS (low voltage differential signaling) logic levels, the data rates of the digital interface 250 are lower, the routing distances of the signals are smaller, and there is no parallel loading involved. The digital interface 250 saves supply current by reducing the swing at the transmitter end to 140 mV minimum, and using a higher line impedance of 240 ohms differential.

The external quartz crystal 209 couples into the oscillator inputs of the frequency controlled clock generator 320. The clock output 210 of the frequency controlled clock generator 320 may be coupled to the baseband DSP IC 204 and its channel demodulator and other digital circuitry.

The serial peripheral interface (SPI) receiver 324 may be used to communicate control information serially between integrated circuits of the system 200. In particular, the baseband DSP IC 204 communicates control information, such as the frequencies, demodulation, and general control for the selected communication channels and systems over the serial control bus 212 to the radio receiver IC 202. The serial control bus 212 is a serial bus.

Referring now to FIG. 4, a magnified view of the block diagram of the baseband DSP integrated circuit 204 is illustrated. The baseband DSP integrated circuit 204 includes one or more low voltage differential input receivers 404I, 404Q, 404SDCK; one or more data synchronizers 406I, 406Q; one or more decimators/filters 408, one or more data filters 410, one or more data demodulators 412; and a serial peripheral interface (SPI) transmitter 414 coupled together as shown and illustrated in FIG. 4. The baseband DSP integrated circuit 204 may further include other digital signal processing circuits/functions 416 coupled to the data demodulator 412 to generate a digital audio data output signal 260. The digital audio data output signal 260 may be converted into an analog signal, amplified by an audio amplifier, and coupled into a speaker (not shown) in order to generate audio sounds.

The one or more pairs of low voltage differential input receivers 404I, 404Q receive the low voltage differential digital bit stream of the I and Q channels from the RF receiver IC 202 and convert them into a single ended high voltage swing digital bit stream of the I and Q channels on chip. There may be one or more pairs used in order to simultaneously support receiving digital audio data over more than one carrier frequency. That is, two or more channels of simultaneous communication may be supported. For example, a user may want to listen to one channel while information from another is simultaneously being stored for later use.

The low voltage differential input receiver 404SDCK receives the sigma-delta clock SDCK 253 from the RF receiver IC 202 and converts it into a single ended high voltage swing sigma-delta clock on chip. The on chip sigma-delta clock is coupled into the decimation filter 408 and the data filter 410. The clock signal CLK 210 is coupled into the demodulator 412 and the other digital circuitry 416.

In the baseband DSP IC 204, the low voltage differential input receivers 404I, 404Q, 404SDCK receive the low voltage swing differential signal generated by the low voltage differential output drivers 314I, 314Q, 314SDCK of the RF receiver IC 202. The low voltage differential input receivers 404I, 404Q, 404SDCK convert the low voltage swing differential signal into a single ended digital data signal having a high voltage swing between a pair of high voltage difference logic levels (e.g., ground and VDD).

The inputs of the data synchronizers 406I, 406Q couple to the respective singled ended outputs of the low voltage differential input receivers 404I, 404Q. In the preferred embodiment of the invention in which the sigma-delta clock is transmitted to the baseband DSP integrated circuit, the data synchronizers 406I, 406Q are simple clock reshapers on the receive side of the interface. In an alternate embodiment of the invention in which the sigma-delta clock is not transmitted to the baseband DSP integrated circuit, the data synchronizers 406I, 406Q are delay locked loops (DLL) on the receive side of the interface to align the phase of the local clock signal with a phase of the transitions in the single ended digital data signal to properly sample the single ended digital data signal. The data synchronizers 406I, 406Q essentially recover the data transmitted over the interface 250.

The one or more decimator/filters 408 are samplers that sample the single ended digital data signal to reduce the sampling rate of the digital data signal by K and to match the frequency of the digital channel filter clock. In addition to lowering the sampling rate of the I and Q serial bit stream, the one or more decimators/filters 408 can provide digital filtering, detect data from noise, and convert serial bits of sampled data into parallel data to generate received I and Q parallel data sampled.

The one or more data filters 410 are coupled to the one or more one or more decimator/filters 408 to receive the I and Q parallel data samples and perform data filtering specifically for the type of digital audio radio system selected. The filtered I and Q parallel data samples generated by the one or more data filters 410 are coupled into the one or more data demodulators 412.

The one or more data demodulators 412 receive the I and Q parallel data samples and demodulate the channel modulation of the digital audio radio system, such as the modulation of SDARS. That is, the demodulator 412 digitally demodulates the parallel digital data samples into data words. The data words may be the received source of audio data or may require further signal processing by the digital signal processing integrated circuit. In which case, the output of the one or more data demodulators 412 is coupled into the other digital signal processing block 416. The one or more data demodulators 412 are programmable based on the selected digital audio system and digital channel over which the audio data is to be received.

As discussed previously, the other digital signal processing circuits/functions 416 may be coupled to the data demodulator 412 to generate the digital audio data signal 260 for use by an audio amplifier (not shown).

The DSP IC 204 is programmable in that the demodulator 412 can be reprogrammed to selectively demodulate signals from the various radio systems. The DSP IC 204 further includes the data filter 410 that is programmable to selectively filter the signals received over the various radio systems. That is, the active channel filtering is performed in the DSP 204 using digital filtering techniques. Thus, the filter coefficients can be easily modified as well as the carrier frequency selected for whatever radio system over which communication is to be received. The flexibility provided by the invention enables the use of one radio chip and one DSP chip to address multiple communications standards used by the various radio systems by software selection, referred to as “Software Radio”.

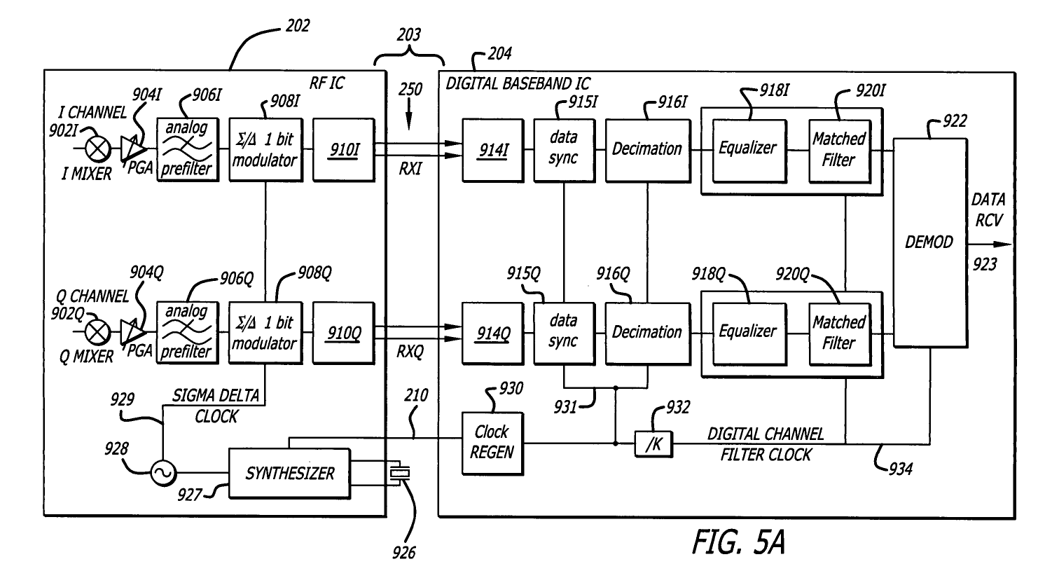

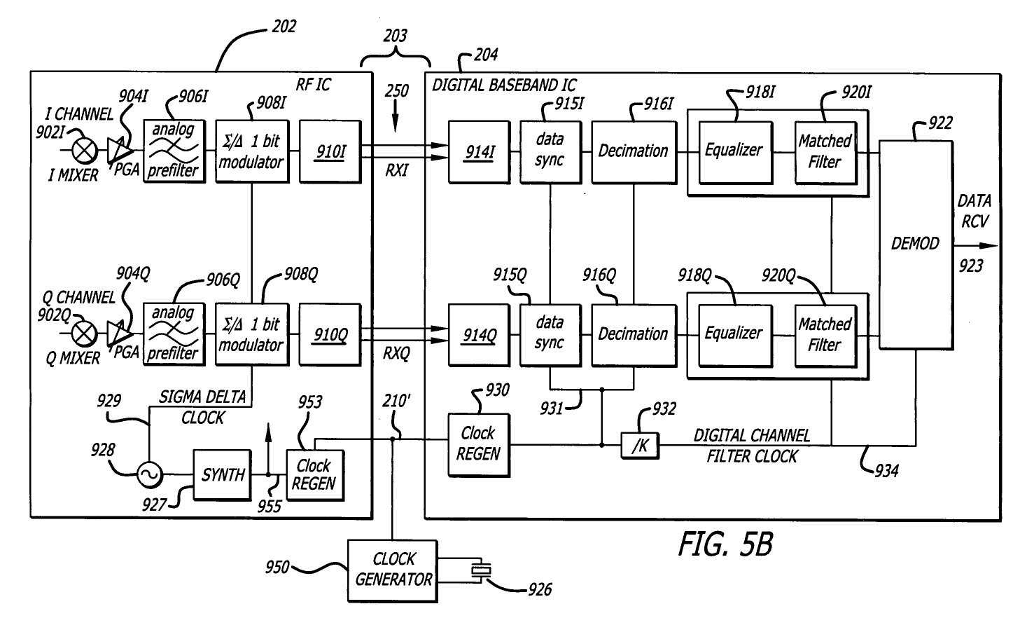

Referring now to FIG. 5, a block diagram of the receive channel 250 of the digital interface 203 is illustrated in greater detail between the radio frequency integrated circuit 202 and the baseband digital signal processing IC 204. The in-phase or real component (I) receive channel and the quadrature or imaginary component (O) receive channel of the receive channel 250 are mirror images of one another but carry different data.

In the radio frequency IC 202, the I receive channel includes a mixer or down-converter 902I, a programmable gain amplifier (PGA) 904I, an analog prefilter 906I, a sigma-delta modulator 908I, and a low voltage differential output driver 910I coupled in series together. The low voltage differential output driver 910I couples to a pair of wire traces between the radio frequency integrated circuit 202 and the baseband digital signal processing IC 204 to carry the differential signal there-between. The Q receive channel in the radio frequency IC 202 includes a mixer or down-converter 902Q, a programmable gain amplifier (PGA) 904Q, an analog prefilter 906Q, a sigma-delta modulator 908Q, and a low voltage differential output driver 910Q coupled in series together. The low voltage differential output driver 910Q couples to a pair of wire traces between the radio frequency integrated circuit 202 and the baseband digital signal processing IC 204 to carry the differential signal there-between.

The radio frequency IC 202, further includes a clock synthesizer 927 to couple to an external quartz crystal 926, and a local oscillator 928 coupled to the clock synthesizer 927 to generate a sigma-delta clock 929 for the sigma-delta modulators 908I, 908Q. The radio frequency IC 202 further includes a low voltage differential output driver 910SDCK.

In the baseband DSP IC 204, the I receive channel includes a low voltage differential input receiver 914I, a data synchronizer 915I, a decimator 916I, an equalizer 918I, and a matched filter 920I coupled in series together. The Q receive channel in the baseband DSP IC 204 includes a low voltage differential input receiver 914Q, a data synchronizer 915Q, a decimator 916Q, an equalizer 918Q, and a matched filter 920Q coupled in series together.

The baseband DSP IC 204 further includes a low voltage differential input receiver 914SDCK, a clock regenerator 930 to generate a local clock signal 931 from the reference clock signal 210, a clock divider 932 to divide the frequency of the local clock signal 931 by K down to a frequency of a digital channel filter clock 934, and a demodulator 922 to couple to the matched filters 920I, 920Q. The demodulator 922 receives data from both the I and Q receive channels to form a received digital data signal (DATA RCV) 923.

In the RF IC 202, the mixers 902I, 902Q are used to down convert the received I and Q analog data signals from the carrier frequencies of the respective communication system channel into baseband signals. That is, the mixers strip away the carrier frequency from the I and Q analog signals. In other words, the mixers extract the analog data signals at baseband frequency from the received analog signals at the carrier frequencies. The programmable gain amplifiers 904I, 904Q, are used to adjust the gain and effectively compress the dynamic range in front of the sigma-delta data modulators 908I, 908Q.

Analog filtering is employed within the RF ICs which may be passive or active. Channel filtering is subsequently completed in the digital domain by digital filters in the baseband DSP IC. The design is optimized such that the filtering performed in the digital domain by digital filters in the baseband DSP IC removes the undesired signals and with no extra effort. The digital filters in the baseband DSP IC also filter out the inherent quantization noise added to the signal by the single bit modulation performed by the sigma-delta modulators 908I, 908Q.

The analog filters 906I, 906Q are analog filters that protect the sigma-delta data modulators 908I, 908Q from high interference signals. The analog filters 906I, 906Q are low-pass filters in the baseband frequency of interest. These analog filters 906I, 906Q filter out the unwanted frequency of signals generated by the down converters 902I, 902Q.

The sigma-delta modulators 980I, 908Q are over sampling quantizers and essentially convert an analog signal into a serial digital bit stream. In comparison with the baseband signal, the sigma-delta modulators 980I, 908Q over sample the analog signal at a rate much greater than the Nyquest rate in response to the frequency of the sigma-delta clock 929. The analog signal is quantized into two levels as a digital signal with a high voltage swing between a pair of high voltage difference logic levels (e.g., ground and VCC or −VCC and +VCC). Over time as more samples of the analog signal are taken by the sigma-delta modulators 980I, 908Q, a single ended serial digital bit stream is formed having the high voltage swing.

The frequency of the sigma-delta clock 929 and the sampling rate of the sigma-delta modulators 980I, 908Q varies depending upon the type of digital audio radio system and its frequency bands.

The digital bit stream out of the modulators 908I, 908Q is transported across the interface 203. Over the interface 203 the data need not be encoded in that the data is single bit NRZ serial data stream. The logic of the sigma-delta modulator 908I, 908Q may assure that a bit change occurs in the single bit NRZ serial data stream at least once for every 32 bits. As the digital interface 203 is a serial bit stream with no packetizing of data, a data exchange protocol need not be used across the interface to recover the data on each side. Moreover, the digital interface 203 may be unidirectional when data is only to be transmitted or received.

In an alternate embodiment, the over sampling clock for the modulator/demodulator may be separately generated within the RF IC 202 (e.g., sigma delta clock 929) and the baseband DSP IC 204 (e.g., local clock signal 931). In this case, clocks at the bit rates are not explicitly exchanged between the RF IC 202 and the baseband DSP IC 204. Instead, a common low reference frequency may be used to internally generate a clock at the bit rates in order to reduce noise. For example, a reference frequency may be around 20 MHz, while the data rate over the digital interface 203 can be above 200 MHz.

In order to recover data, the receiving side of the interface 203 uses a data synchronizer 915I, 915Q, such as a delay lock loop (DLL), to retrieve the mid sampling point of the serial I and Q bit streams transferred over the interface.

The I and Q bit streams are transported separately in the typical implementation over the interface between the radio frequency integrated circuits and the baseband DSP integrated circuit. However, in the invention, I and Q may also be interleaved onto the same pair of differential serial signal lines. With respect to polarity, the I component leads the Q component for negative frequency deviations.

The low voltage differential output drivers 910I, 910Q receive the single ended serial digital bit stream (I and Q bit streams) from the sigma-delta modulators 908I, 908Q having the high voltage swing between the pair of high voltage difference logic levels (e.g., ground and VCC). From a clock generator, the low voltage differential output driver 910SDCK receives a single ended sigma delta clock signal having a high voltage swing between a pair of high voltage difference logic levels (e.g., ground and VCC). In response to the single ended digital signal with the high voltage swing between the pair of high voltage difference logic levels, the low voltage differential output drivers 910I, 910Q, 910SDCK generate a double ended low voltage swing differential signal between a pair of low voltage difference logic levels.

In one embodiment, the low voltage differential output drivers 910I, 910Q, 910SDCK can generate logic levels and the low voltage differential input receivers 914I, 914Q, 914SDCK can receive logic levels in accordance with a modified LVDS standard of differential signals. In which case, the electrical characteristics of these modified LVDS signals communicated over the interface 203 may be found in the table previously described. The LVDS standard is described in an American National Standards Institute specification titled “Electrical Characteristics of Low Voltage Differential Signaling (LVDS) Interface Circuits” published on Jan. 1, 2001 as ANSI TIA/EIA-644-A.

In comparison with the standard LVDS (low voltage differential signaling) logic levels, the data rates of the digital interface 203 are lower, the routing distances of the signals are smaller, and there is no parallel loading involved. The digital interface 203 saves supply current by reducing the swing at the transmitter end to 140 mV typically, and by using a higher line impedance of 240 ohms differential.

In the baseband DSP IC 204, the low voltage differential input receivers 914I, 914Q, 914SDCK receive the low voltage swing differential signal generated by the low voltage differential output drivers 910I, 910Q, 910SDCK of the RF IC 202. The low voltage differential input receivers 914I, 914Q, 914SDCK convert the low voltage swing differential signal into a single ended digital data signal having a high voltage swing between a pair of high voltage difference logic levels (e.g., ground and VDD).

The data synchronizers 915I, 915Q may be delay locked loops (DLL) on the receive side of the interface to align the phase of the local clock signal 931 with a phase of the transitions in the single ended digital data signal to properly sample the single ended digital data signal.

The decimators 916I, 916Q are samplers that sample the single ended digital data signal to reduce the sampling rate of the digital data signal by K to match the frequency of the digital channel filter clock 934. The decimators 916I, 916Q further filter and convert the serial bit stream into parallel words. The rate of conversion is a function of the sampling reduction factor K. Additionally, as the sampling rate is lowered, the number of bits in the parallel word increase. The serial bit stream to parallel word conversion provided by the decimators 916I, 916Q is essentially a digital averaging process of the incoming serial bit stream and not an ordinary serial to parallel conversion.

The single bit stream of the digital interface 203 enables the system to tolerate small residual bit errors in the bit stream with no loss of data.

In one embodiment, an internal clock generator is used in the radio frequency integrated circuit to generate the clock signal 210 to synchronize the radio frequency integrated circuit and the digital signal processing integrated circuit. In another embodiment, the internal clock generator may be within the digital signal processing integrated circuit to generate the clock signal 210 which would then be coupled to the radio frequency integrated circuit. In yet another embodiment, the clock signal 210 can be generated externally from the radio frequency integrated circuit and the digital signal processing integrated circuit.

The invention simplifies end user software development as one radio platform can be used for multiple digital audio radio systems. The invention further allows digital matching of analog imperfections, such as predistortion of transmitters, nonlinearities in the receiver, and intentionally distort signals to better handle interference. The invention enables low power consumption because digital filters can be more greatly utilized and digital and analog circuitry can be implemented in their most optimized process technology, respectively.

Additionally, while certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

For example, the invention has been described and illustrated as using sigma-delta modulators. Other modulators that receive an analog input signal and have a single bit output to provide a serial digital data stream may be used. For example, the sigma-delta modulators may be delta modulators, in another embodiment. In yet another embodiment, the sigma-delta modulators may be modulating analog-to-digital converters with a single digital bit output to provide the serial bit stream.

The invention has been illustrated with respect to a mobile subscriber unit in a digital audio radio system. However, the invention is equally applicable to stationary subscriber units. Moreover, the digital interface 250 may be applied to other types of radios and radio circuitry.

Furthermore, it is possible to implement the invention or some of its features in hardware, firmware, software or a combination thereof where the software is provided in a processor readable storage medium such as magnetic, optical, or semiconductor storage. While the invention has been described in particular embodiments, the invention should not be construed as limited by such embodiments. Rather, the invention should be construed according to the claims that follow below.

1. A digital audio satellite radio receiver comprising:
a radio frequency receiver integrated circuit including
a modulating analog to digital converter with an analog input and a serial digital output, the analog input to receive a digital audio satellite radio signal, and
an output driver having an input coupled to the serial digital output of the modulating analog to digital converter, the output driver having a digital output; and
a processor coupled to the radio frequency receiver integrated circuit.

2. The digital audio satellite radio receiver of claim 1, wherein
the processor includes
an input receiver coupled to the digital output of the output driver of the radio frequency receiver integrated circuit, the input receiver having a digital input to couple to the digital output of the output driver, the input receiver having a serial digital output.

3. The digital audio satellite radio receiver of claim 2, wherein
the processor is a digital signal processor and further includes
a decimator coupled to the serial digital output of the input receiver, the decimator having a digital output, and
a demodulator coupled to the digital output of the decimator.

4. The digital audio satellite radio receiver of claim 2, wherein
the processor includes programmable instructions to provide
a decimator coupled to the serial digital output of the input receiver, the decimator having a digital output, and
a demodulator coupled to the digital output of the decimator.

5. The digital audio satellite radio receiver of claim 1, wherein
the modulating analog to digital converter is a single bit sigma delta modulator.

6. The digital audio satellite radio receiver of claim 1, wherein
the modulating analog to digital converter is a single bit delta modulator.

7. A digital audio radio comprising:
an antenna to extract a digital audio radio signal broadcast from at least one satellite in geosynchronous orbit with the earth as an analog signal,
a radio frequency receiver integrated circuit coupled to the antenna, the radio frequency receiver integrated circuit including
a single bit modulator to convert the analog signal into a serial digital bit stream; and
a digital signal processing integrated circuit coupled to the radio frequency receiver integrated circuit, the digital signal processing integrated circuit to receive the serial digital bit stream and extract a digital audio signal from the serial digital bit stream.

8. The digital audio radio of claim 7, wherein
the radio frequency receiver integrated circuit further includes
an output driver coupled to the single bit sigma delta modulator, the output driver to recieve the serial digital bit stream and drive it out from the radio frequency integrated circuit into the digital signal processing integrated circuit; and
the digital signal processing integrated circuit further includes
an input receiver coupled to the output driver of the radio frequency receiver integrated circuit, the input receiver to receive the serial digital bit stream.

9. The digital audio radio of claim 8, wherein
the digital signal processing integrated circuit further includes
a decimator coupled to the input receiver, the decimator to receive the serial digital bit stream, lower a sampling rate of the serial digital bit stream and convert the serial digital bit stream into parallel digital data samples, and
a demodulator coupled to the decimator, the demodulator to digitally demodulate the parallel digital data samples into data words for further signal processing by the digital signal processing integrated circuit.

10. The digital audio radio of claim 8, wherein
the output driver is a differential output driver to output a differential signal, and
the input receiver is a differential input receiver to receive the differential signal.

11. The digital audio radio of claim 8, wherein
the output driver is a low voltage swing differential output driver to output a low voltage swing differential signal, and
the input receiver is a low voltage swing differential input receiver to receive the low voltage swing differential signal.

12. The digital audio radio of claim 7, wherein
the single bit modulator is a single bit sigma delta modulator.

13. The digital audio radio of claim 7, wherein
the single bit modulator is a single bit delta modulator.

14. The digital audio radio of claim 7, wherein
the single bit modulator is a single bit analog to digital converter and a modulator coupled together.

15. A digital audio radio frequency integrated circuit to couple to an antenna to receive a wireless digital audio signal, the integrated circuit comprising:
an amplifier to couple to an antenna to receive a wireless digital audio signal as an analog signal;
a single bit modulator coupled to the amplifier, the single bit modulator to convert the analog signal into a serial digital bit stream, and
an output driver coupled to the single bit modulator, the output driver to drive the serial digital bit stream out from the radio frequency integrated circuit to a digital signal processing integrated circuit.

16. The integrated circuit of claim 15, wherein
the single bit modulator is a single bit sigma delta modulator.

17. The integrated circuit of claim 15, wherein
the single bit modulator is a single bit delta modulator.

18. The integrated circuit of claim 15, wherein
the single bit modulator is a single bit analog to digital converter and a modulator coupled together.

19. The integrated circuit of claim 15, wherein
the output driver has a low voltage output swing, the output driver to drive the serial digital bit stream out of the radio frequency integrated circuit with the low voltage output swing.

20. The integrated circuit of claim 19, wherein
the low voltage output swing between a high logic level and a low logic level is less than an output swing between a high logic level and a low logic level of a three volt complementary metal oxide semiconductor (CMOS) process technology.

21. The integrated circuit of claim 19, wherein
the low voltage output swing between a high logic level and a low logic level is less than an output swing between a high logic level of 1.8 volts and a low logic level of 0.2 volts.

22. The integrated circuit of claim 19, wherein
the output driver translates first voltage levels of a first output voltage swing of the serial digital bit stream into second voltage levels with a second output voltage swing less than the first output voltage swing.

23. The integrated circuit of claim 22, wherein
the third voltage levels are substantially the same as the first voltage levels.

24. The integrated circuit of claim 15, wherein
the output driver is double ended and generates a differential signal to represent the serial digital bit stream.

25. The integrated circuit of claim 15, wherein
the output driver is a low voltage differential signaling transmitter to generate a low voltage differential output signal with a low voltage differential swing.

26. The integrated circuit of claim 25, wherein
the low voltage differential swing is at least 100 milli-volts.

27. The integrated circuit of claim 15, wherein
the serial digital bit stream is a rectangular waveform.

28. The integrated circuit of claim 15, wherein
a clock is coupled to the single bit modulator, a frequency of the clock to provide a data rate in the serial digital bit stream.

29. The integrated circuit of claim 28, wherein
the frequency of the clock is programmable to provide various data rates in the serial digital bit stream for various digital audio satellite radio systems.

30. The integrated circuit of claim 15, wherein
a down converter coupled between the amplifier and the single bit modulator, the down converter to extract the analog signal from the wireless digital audio signal.

31. A digital audio radio frequency integrated circuit comprising:
at least one gain amplifier to couple to an antenna to receive a first digital audio radio frequency signal of a first selectable carrier frequency;
at least one down converter coupled to the at least one gain amplifier, the at least one down converter to extract a first analog signal from the first wireless radio frequency signal;
at least one single bit sigma delta modulator coupled to the at least one down converter, the at least one single bit sigma delta modulator to convert the first analog signal into a first serial digital bit stream; and
at least one output driver coupled to the at least one single bit sigma delta modulator, the at least one output driver to provide a low voltage output swing of the first serial digital bit stream to reduce noise generation as the first serial digital bit stream is coupled to another integrated circuit.

32. A system comprising:
a radio frequency integrated circuit including
a modulating analog to digital converter with a single bit output, the modulating analog to digital converter to convert an analog input signal of a digital audio signal into a serial digital bit output stream, and
an output driver coupled to the single bit analog to digital converter, the output driver to drive the serial digital bit stream out from the radio frequency integrated circuit; and
a processor coupled to the radio frequency integrated circuit to receive the serial digital bit stream and recover the digital audio signal.

33. The system of claim 32, wherein
the processor includes
an input receiver coupled to the output driver of the radio frequency integrated circuit, the input receiver to receive the serial digital bit stream.

34. The system of claim 33, wherein
the processor is a digital signal processor and further includes
a decimator coupled to the input receiver, the decimator to receive the serial digital bit stream, lower a sampling rate of the serial digital bit stream, and convert the serial digital bit stream into parallel digital data samples, and
a demodulator to digitally demodulate the parallel digital data samples into data words for further signal processing by the digital signal processing integrated circuit.

35. The system of claim 33, wherein
the processor includes programmable instructions to provide
a decimator coupled to the input receiver, the decimator to receive the serial digital bit stream, lower a sampling rate of the serial digital bit stream, and convert the serial digital bit stream into parallel digital data samples; and
a demodulator coupled to the decimator, the demodulator to digitally demodulate the parallel digital data samples into data words for further signal processing by the digital signal processing integrated circuit.

36. A digital audio satellite system comprising:
at least one satellite in geosynchronous orbit with the earth, the at least one satellite to broadcast wireless digital audio signals to a portion of the earth over a carrier frequency;
a digital radio having an antenna to receive the wireless digital audio signals, the digital radio having
a radio frequency integrated circuit including
a single bit sigma delta modulator with an analog input and a serial digital output, and
an output driver having an input coupled to the serial digital output of the single bit sigma delta modulator, the output driver having a differential output; and
a digital signal processing integrated circuit including
an input receiver coupled to the output driver of the radio frequency integrated circuit, the input receiver having a differential input to couple to the differential output of the output driver, the input receiver having a serial digital output.

37. The system of claim 36, wherein
the output driver to drive a serial digital bit stream out from the radio frequency integrated circuit with a low voltage differential output swing to lower noise.

38. The system of claim 37, wherein
the input receiver to receive the serial digital bit stream with the low voltage differential output swing.

39. The system of claim 36, wherein
the digital signal processing integrated circuit further includes
a decimator coupled to the serial digital output of the input receiver, the decimator having a parallel digital output, and
a demodulator coupled to the parallel digital output of the decimator.
